(19) United States
(12) Patent Application Publication
(10) Pub. No.: US 2014/0129636 A1
(43) Pub. Date: May 8, 2014

(54) METHOD AND APPARATUS FOR VISUALIZING SOCIAL NETWORK ELEMENTS

(71) Applicant: ELECTRONICS AND TELECOMMUNICATIONS RESEARCH INSTITUTE, Daejeon (KR)

(72) Inventors: Jong-Hoon LEE, Daejeon (KR); Hoon Ki LEE, Daejeon (KR); Jung Tae KIM, Daejeon (KR); Jongyoul PARK, Daejeon (KR)

(73) Assignee: ELECTRONICS AND TELECOMMUNICATIONS RESEARCH INSTITUTE, Daejeon (KR)

(21) Appl. No.: 14/024,792

(22) Filed: Sep. 12, 2013

(30) Foreign Application Priority Data
Nov. 7, 2012 (KR) 10-2012-0125664

(51) Int. Cl. H04L 29/06

(52) U.S. Cl. CPC H04L 65/40
USPC 709/204

(57) ABSTRACT

A visualizing apparatus of social network elements collects social network relationship information, community information, and content information of a user, generates relationship data between the user, the contents, and the community using the collected information, and visualizes an association relationship between the user, the contents, and the community using the relationship data between the user, the contents, and the community.

### CROSS-REFERENCE TO RELATED APPLICATION

This application claims priority to and the benefit of Korean Patent Application No. 10-2012-0125664 filed in the Korean Intellectual Property Office on Nov. 7, 2012, the entire contents of which are incorporated herein by reference.

### BACKGROUND OF THE INVENTION

(a) Field of the Invention

The present invention relates to a method and apparatus for visualizing a relationship of social network elements. More particularly, the present invention relates to a method and apparatus for visualizing a community and contents that are related to a user as well as the user corresponding to an element on a social network.

(b) Description of the Related Art

A social network service (SNS) shares an individual's contents and information based on the Internet, and provides a service for supplying necessary information and solving a problem through formation of a social relationship.

With fast spread and development of smart phones and tablet PCs, the SNS provides a service to a user even in a mobile environment over a terminal of a fixed position, such as an existing PC, and nowadays, SNSs such as Twitter and Facebook have been provided.

Users form a relationship between themselves through the SNS and generate many contents within the formed relationship, and the generated contents are collected by a provider and a server that provide the SNS.

As the number of users using the SNS rapidly increases, the users may form a community based on a specific topic, or a specific location or purpose on the SNS, and share contents including experience and knowledge thereof within such a community.

In general, a social network is formed through a relationship of nodes forming the network. The social network may be visualized through a network graph interface such as a social graph, a node of the social graph is expressed with one object node of the network graph interface, a relationship of the social graph is a line of the network graph interface, and a relationship set of the social graph is visualized with a group expression method of the network graph interface.

In other words, a common social graph is a structure that is used for expressing a social network using a node and a link, the node represents each user on the social network, and the link expresses a relationship between the nodes and visualizes a characteristic of the social network.

Such an existing social graph analyzes clustering and density on a social network by visualizing a relationship between users or searches for an opinion leader having much connection and relationships and uses this for marketing.

Data on a common social network is information of a text or list form, and in order to effectively express data on such a social network to the user, an intuitive expression of an interface for expression and relationship of data on the social network is necessary. For this purpose, when disposing a node on the social graph, various algorithms for disposing a node having a high relationship, i.e., adjacent nodes at a short range are researched, and many methods and technologies for effectively expressing have been developed, but in a social graph based on a simple relationship between users, as the number of users, i.e., the number of nodes, increase, there is a drawback that much cost and resources for analysis are consumed.

Further, as a community that is formed by the user and contents that are shared within the community as well as a social graph in which only an existing user becomes an element have a relationship with the user like a tagged user, technology that may visualize and express a relationship between the user, the community, and the contents is requested.

### SUMMARY OF THE INVENTION

The present invention has been made in an effort to provide a method and apparatus for visualizing social network elements having advantages of visualizing a relationship with a community to which a user belongs and contents that are associated with the user as well as the user.

An exemplary embodiment of the present invention provides a method of visualizing social network elements in a visualizing apparatus of social network elements. The method includes: collecting social network relationship information, community information, and content information of a user; generating relationship data between the user, contents, and community using the collected information; and visualizing an association relationship between the user, the contents, and the community using the relationship data between the user, the contents, and the community.

The visualizing of an association relationship may include: generating a user node, a content node, and a community node, respectively; and tying the user node, the content node, and the community node with a link according to the association relationship between the user, the contents, and the community.

The tying of the user node may include: generating a user layer, a content layer, and a community layer; determining positions of the user node, the content node, and the community node to dispose at the user layer, the content layer, and the community layer, respectively; and disposing the user node, the content node, and the community node at the respective determined positions.

The determining of positions may include: determining a degree of the user using relationship data between the user, the contents, and the community; setting an area at which the user node is to be disposed to correspond to the degree of the user; and determining a position of the user node within the set area according to a distance to a community to which the user belongs.

The determining of positions may further include: determining betweenness of the community using relationship data between the user, the contents, and the community; and setting an area of the community according to the betweenness.

The determining of positions may further include disposing a content node that is associated with the corresponding user of the user node.

Another embodiment of the present invention provides a visualizing apparatus of social network elements. The visualizing apparatus includes a data collector, a relationship data generator, and a visualizing outputter. The data collector collects social network relationship information, community information, and content information of a user. The relationship data generator generates relationship data between the user, contents, and a community using the collected information. The visualizing outputter disposes a user node that is related to the community of a community node using the relationship data between the user, the contents, and the community and disposes a community node that is related to the user of the user node and visualizes an associated node by tying with a link.

The visualizing outputter includes a node position determiner and a layer manager. The node position determiner determines layers and positions at which the user node, the content node, and the community node are to be disposed. The layer manager generates a user layer, a content layer, and a community layer and disposes the user node, the content node, and the community node at the respective determined layers and positions and ties an associated node with a link.

The node position determiner may include: an information manager that determines a degree of the user and a betweenness of the community; an area setter that sets an area at which the community layer is to be positioned at the community layer based on the betweenness of the community and that sets an area at which the user layer is to be positioned at the user layer based on the degree of the user; and a position calculator that determines a position of the user node within an area at which the user node is to be positioned based on a distance to a community to which the user belongs.

The position calculator may determine a position in which the sum of a distance to at least one community node to which the user node belongs is a minimum as a position of the user node within an area at which the user node is to be positioned.

The information manager may determine the degree using a content number and a user number that are related to the user, and determine a betweenness using the user number belonging to the community and the content number that is related to the user belonging to the community.

### BRIEF DESCRIPTION OF THE DRAWINGS

FIG. 1 is a diagram illustrating a concept of a method of visualizing social network elements according to an exemplary embodiment of the present invention.

FIG. 2 is a block diagram illustrating a visualizing apparatus of social network elements according to an exemplary embodiment of the present invention.

FIG. 3 is a block diagram illustrating a node position determiner according to an exemplary embodiment of the present invention.

FIGS. 4 and 5 are diagrams illustrating an area of a community and a user's area, respectively.

FIG. 6 is a diagram illustrating an example of a method of determining a user's position in the node position determiner of FIG. 3.

FIG. 7 is a diagram illustrating a state in which a user node is randomly disposed.

FIG. 8 is a diagram illustrating a state in which a user node is disposed at a position that is determined by a node position determiner according to an exemplary embodiment of the present invention.

FIG. 9 is a flowchart illustrating a method of visualizing social network elements according to an exemplary embodiment of the present invention.

FIG. 10 is a diagram illustrating an example of social network elements that are displayed on a GUI by a visualizing apparatus of social network elements according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for visualizing social network elements according to an exemplary embodiment of the present invention will be described in detail with reference to the drawings.

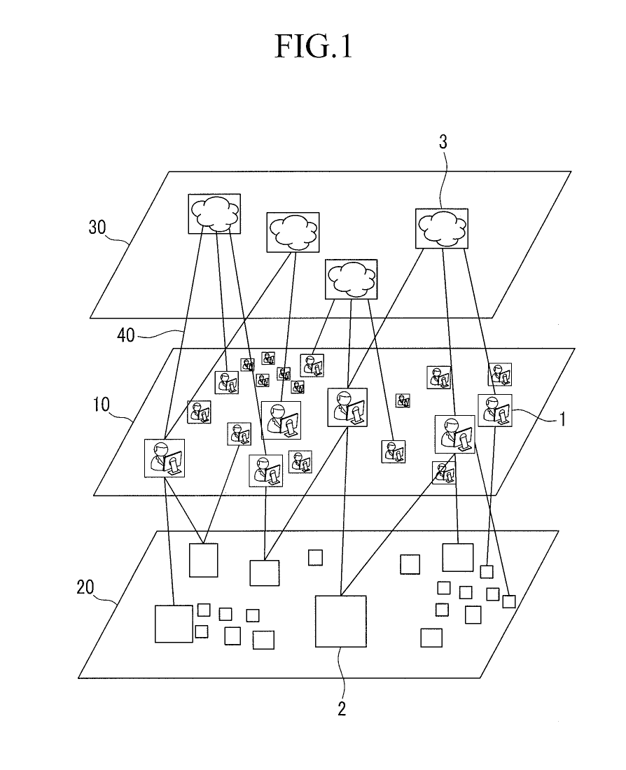

FIG. 1 is a diagram illustrating a concept of a method of visualizing social network elements according to an exemplary embodiment of the present invention.

Referring to FIG. 1, a social network is formed with a user 1, contents 2, and a community 3.

The contents 2 are related to the user 1 and may be generated by the user 1. The contents 2 may include documents, knowledge, or experience.

The community 3 is formed by users based on a specific topic or a specific location or purpose.

The user 1 has a relationship with another user and may form one community 3. For example, several kinds of communities for a company, a school, or an interest field may exist. The user may generate various forms of contents within the community as a constituent element of the community, and the generated contents may be circulated while moving the community.

In other words, a specific content may have an association relationship with the user who generates the contents and an association relationship with a circulated community while being circulated to communities by several paths. Communities in which such contents are circulated have a relationship between the communities. Such relationship information may finally provide community information and user information as related information of contents as well as the contents as a search result of a specific word.

For example, the user may write a comment of a “camera A” in a camera club, and other users may write additional contents in the comment or another camera club may scrap or recommend the comment. In this case, first generated contents have a relationship with another camera club and a user who circulates the contents as well as a first written user, and when there is much contents circulation between such two clubs, the two clubs have a relationship. When such relationship information is maintained and managed, if the user finds the “comment of the camera A”, by providing information of a related user and a related club as well as the written comment, the user can have intuition of a search, compared with a search result that is provided in a common search system.

Therefore, it is necessary to maintain and manage information of a community and a user that are related to contents as well as the contents.

A visualizing apparatus of social network elements according to an exemplary embodiment of the present invention manages information of the user 1, and the contents 2 and the community 3 that are associated with the user 1, which are social network elements. The visualizing apparatus of social network elements virtually forms a user layer 10, a content layer 20, and a community layer 30 for the user 1, the contents 2, and the community 3, respectively, and disposes each element within the user layer 10, the content layer 20, and the community layer 30 based on each relationship information.

The visualizing apparatus of the social network elements represents each of the user 1, the contents 2, and the community 3 with a node within the user layer 10, the content layer 20, and the community layer 30, and represents an associated node by tying with a link 40 between nodes. In this case, when disposing the contents 2 within the content layer 20, the visualizing apparatus of the social network elements disposes the contents 2 at a periphery of the related user 1, and when disposing the user 1 within the user layer 10, the visualizing apparatus of the social network elements disposes the user at a periphery of the related community 3.

The visualizing apparatus of the social network elements visualizes an association relationship between the user, the community, and the contents on a graphic user interface (GUI).

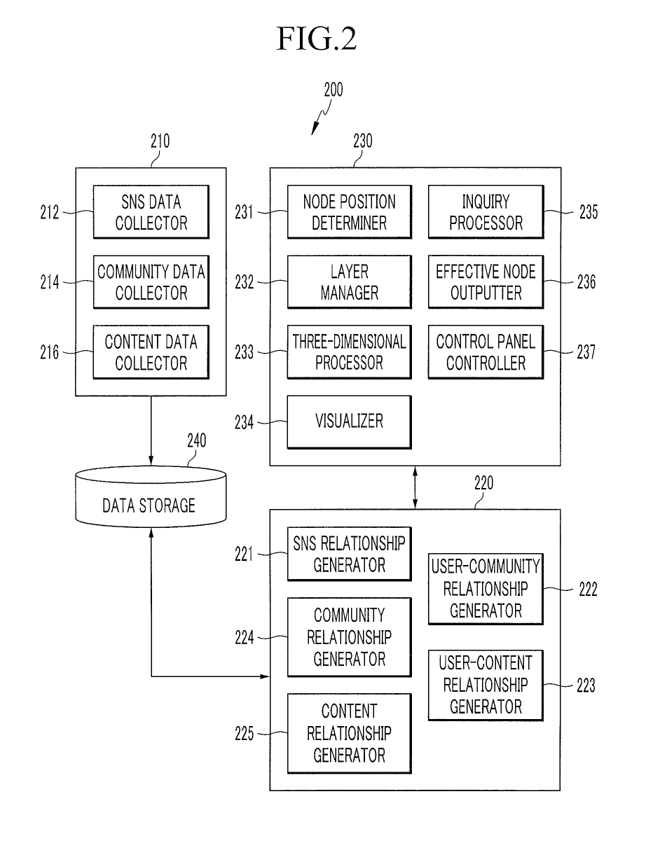

FIG. 2 is a block diagram illustrating a visualizing apparatus of social network elements according to an exemplary embodiment of the present invention.

Referring to FIG. 2, a visualizing apparatus 200 of the social network elements includes a data collector 210, a relationship data generator 220, a visualizing outputter 230, and a data storage 240.

The data collector 210 includes an SNS data collector 212, a community data collector 214, and a content data collector 216.

The SNS data collector 212 collects the user's social network relationship information and stores the collected information at the data storage 240. The user's social network relationship information includes data of a relationship between the users.

The community data collector 214 collects the user's community information and stores the collected community information at the data storage 240. The user's community information includes information about a community to which the user presently belongs and a community to which the user has belonged to in the past.

The content data collector 216 collects the user's content information and stores the collected content information at the data storage 240. The user's content information includes information about contents that the user has been circulated in a community as well as contents that the user generates.

The relationship data generator 220 includes an SNS relationship generator 221, a user-community relationship generator 222, a user-content relationship generator 223, a community relationship generator 224, and a content relationship generator 225.

The SNS relationship generator 221 generates a relationship between users based on the users' social network relationship information that is stored at the data storage 240.

The user-community relationship generator 222 generates a relationship between communities to which users belong based on the users' community information that is stored at the data storage 240.

The user-content relationship generator 223 generates a relationship between contents that the user generates and that the user has tagged based on the user's content information that is stored at the data storage 240.

When a relationship between contents of communities is close, the community relationship generator 224 generates a relationship between the communities. For example, when much overlapped and shared contents exist within a community A and a community B, it may be regarded that the communities have a relationship and thus a relationship between the communities may be generated.

The content relationship generator 225 generates the same relationship between contents for users of contents or users who have tagged contents.

The visualizing outputter 230 visualizes and outputs a relationship between the user, the contents, and the community. The visualizing outputter 230 includes a node position determiner 231, a layer manager 232, a three-dimensional processor 233, a visualizer 234, an inquiry processor 235, an effective node outputter 236, and a control panel controller 237.

The node position determiner 231 determines a layer and a position (coordinates) at which a node corresponding to each of the user, the contents, and the community using relationship data that is generated by the relationship data generator 220 is to be disposed. The node position determiner 231 determines the user's position based on a distance between a community and the user to which the community belongs, and determines a position of contents based on a distance between the user and contents that are related to the user.

The layer manager 232 generates a virtual user layer, a content layer, and a community layer for each element of the user, the contents, and the community, and generates a user node, a content node, and a community node corresponding to each of the user, the contents, and the community. The layer manager 232 disposes a corresponding node at a position that is determined by the node position determiner 231 within each layer, generates an image layer by tying each node by a link (line), and manages the generated image layer.

In order to enhance visualization and intuition of each node, the three-dimensional processor 233 calculates a relationship level of each node, and as the relationship level thereof increases, a size of a corresponding node is increased. In this case, the three-dimensional processor 233 may be set in different sizes according to relationship information of a node, but may form a node in a three-dimensional shape according to relationship information of a node, and may set a node using a color. Here, relationship information of the node is a numerical value of an element that is associated with the node, and for example, a relationship level of a community may represent the number of users belonging to the community.

The visualizer 234 visualizes an association relationship between a user, a community, and contents on a GUI based on an image layer that is generated by the layer manager 232, thereby providing a function of enabling the user to easily know an association relationship between nodes. When actually outputting an associated connection state of nodes on a screen, the visualizer 234 may represent the connection state with an arbitrary connection line.

The inquiry processor 235 receives and processes an input of commands for node selection or node search from the user.

When selecting or searching for a node, the effective node outputter 236 extracts only an element that can be tied to the corresponding node. In this case, only the extracted element is visualized by the visualizer 234 and displayed on a screen.

The control panel controller 237 receives and processes an input of a command for controlling a screen from the user on a GUI.

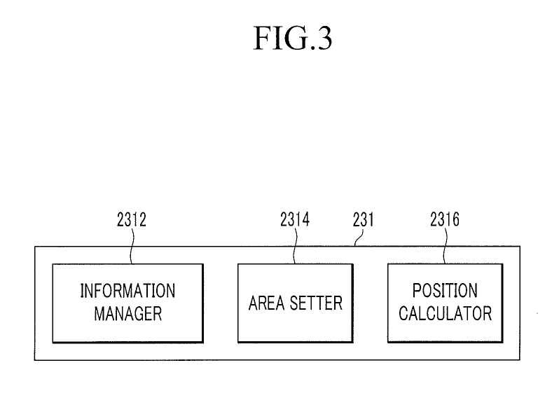

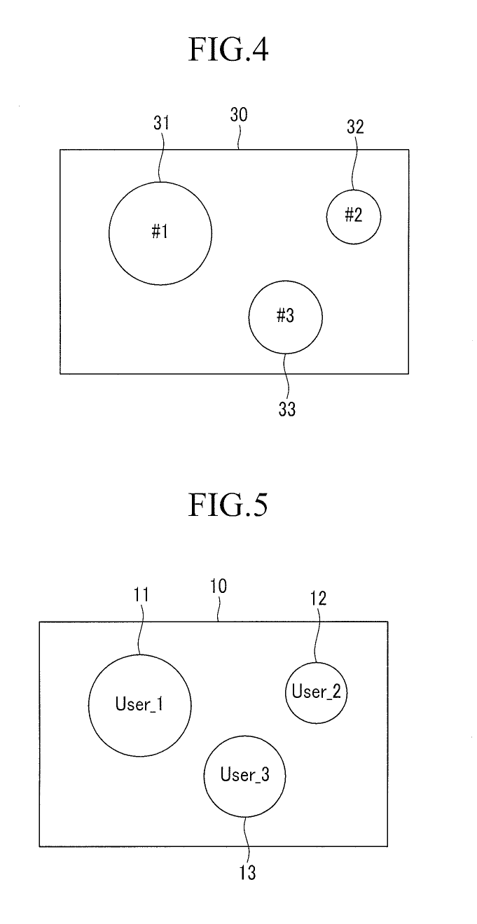

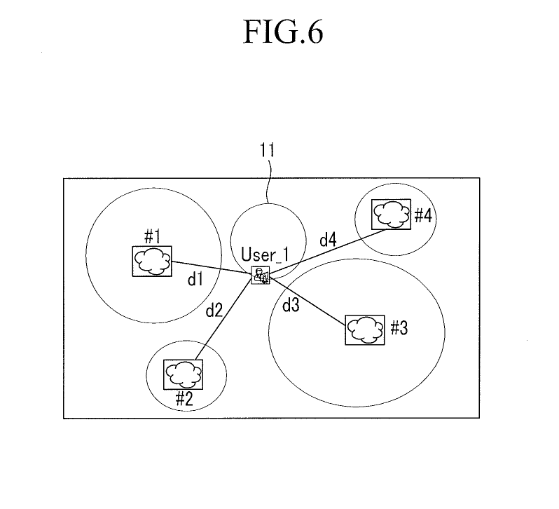

FIG. 3 is a block diagram illustrating a node position determiner according to an exemplary embodiment of the present invention, FIGS. 4 and 5 are diagrams illustrating an area of a community and a user's area, respectively, and FIG. 6 is a diagram illustrating an example of a method of determining a user's position in the node position determiner of FIG. 3.

Referring to FIG. 3, the node position determiner 231 includes an information manager 2312, an area setter 2314, and a position calculator 2316.

The information manager 2312 determines a degree of the user and a betweenness of a community. The degree is determined by the number (social network number) of users that are related to the user and the number of contents that are shared in a community. Here, contents that are shared in the community indicate the number of contents that are uploaded to be shared by users belonging to the community. The degree may be determined by the sum of the number of users that are related to the user and the number of contents that are shared by contents to which the user belongs.

The betweenness is a numerical value representing a relationship between a number of users and contents in the community and the community, and is determined by the number of users belonging to the community and the number of contents that are shared in the community. The betweenness may be determined by the sum of the number of users belonging to the community and the number of contents that each user shares in the community.

The information manager 2312 stores and manages data that is used for determining a degree of the user and a betweenness of the community based on data that is stored at the data storage 240 in a table form such as Tables 1 and 2.

Table 1 represents a degree table, and Table 2 represents a betweenness table.

TABLE 1

| | Subscribing user number | Sharing content number |
|---|---|---|
| Community ID | (Cn) | (Sn) |
| Community #1 | C1 | S1 |
| Community #2 | C2 | S2 |
| Community #3 | C3 | S3 |

TABLE 2

| | Social network number | Sharing content number |
|---|---|---|
| user ID | (Jn) | (Un) |
| user_1 | J1 | U1 |
| user_2 | J2 | U2 |
| user_3 | J3 | U3 |

The area setter 2314 sets areas 31, 32, and 33 at which the communities #1, #2, and #3 may be positioned in the community layer 30 based on betweenness of the community. In this case, because the betweenness becomes the number of elements (users and contents) that are related to the community, as the betweenness of the community increases, the area setter 2314 sets an area of the corresponding community to be larger, as shown in FIG. 4. For example, a circle using the betweenness of the community as a radius may be set as an area of a corresponding community.

Further, the area setter 2314 sets areas 11, 12, and 13 at which a user_1, a user_2, and a user_3 may be positioned in the user layer 10 based on a degree of the user. Because the degree becomes the number of elements that are related to the user, as the user's degree increases, the area setter 2314 sets the corresponding user's area to be larger, as shown in FIG. 5. For example, the area setter 2314 may set a circle using a degree of the user as a radius as the corresponding user's area.

The position calculator 2316 determines a position of each community based on an area of the community. Next, by calculating a distance to a community to which the user belongs, the position calculator 2316 determines a position at which the sum of a distance to a community to which the user belongs becomes a minimum within an area at which the user may be positioned as the user's position. The position calculator 2316 determines a position of contents that are related to the user as an adjacent position of the user.

For example, as shown in FIG. 6, when the user_1 belongs to four communities #1-#4, the position calculator 2316 determines a position P1 at which the sum of distances d1, d2, d3, and d4 to the four communities #1-#4 becomes a minimum as the user's position within the area 11 at which the user_1 may be positioned.

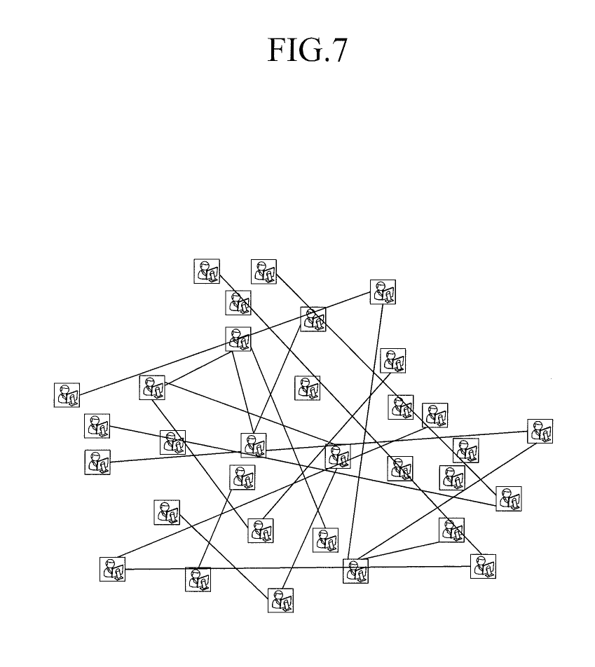

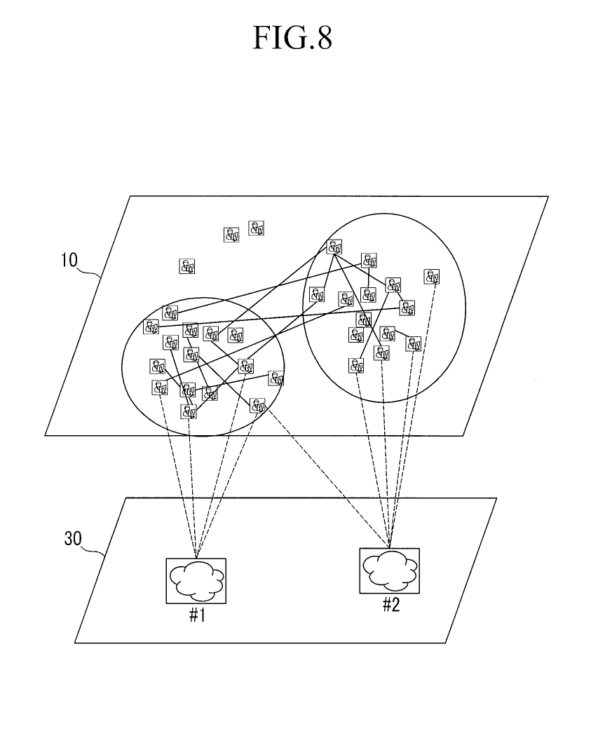

FIG. 7 is a diagram illustrating a state in which a user node is randomly disposed, and FIG. 8 is a diagram illustrating a state in which a user node is disposed at a position that is determined by a node position determiner according to an exemplary embodiment of the present invention.

As shown in FIG. 7, when the user nodes are randomly disposed, a length of a tied link between the user nodes increases within a social graph, and as the number of user nodes increases, the user nodes have a clustered form and thus it is difficult to analyze the user nodes.

However, when the user nodes are disposed at positions that are calculated by the position calculator 2316 according to an exemplary embodiment of the present invention, as shown in FIG. 8, an effect in which users belonging to each of the communities #1 and #2 are visually gathered at the user layer 10 based on the two communities #1 and #2 is obtained and thus the user's intuition can be enhanced.

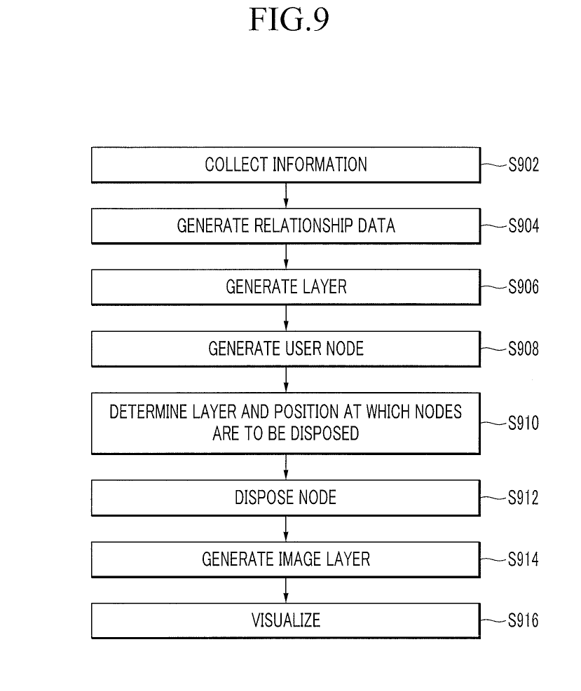

FIG. 9 is a flowchart illustrating a method of visualizing social network elements according to an exemplary embodiment of the present invention.

Referring to FIG. 9, the data collector 210 collects social network relationship information, community information, and content information of the user (S902), and stores the collected information data at the data storage 240.

The relationship data generator 220 generates relationship data between the user, the contents, and the community based on the collected social network relationship information, community information, and content information of the user (S904). The relationship data between the user, the contents, and the community may include relationship information between the users, relationship information between communities to which the users belong, relationship information between the user and contents, relationship information between communities, and relationship information between contents in which users are the same.

The layer manager 232 of the visualizing outputter 230 generates a virtual user layer, a content layer, and a community layer for the user, the contents, and the community, respectively (S906). The layer manager 232 generates a user node, a content node, and a community node corresponding to the user, the contents, and the community, respectively (S908). In this case, the size of each node may be differently set according to a relationship level of each node by the three-dimensional processor 233 of the visualizing outputter 230.

The node position determiner 231 of the visualizing outputter 230 determines layers and positions at which the user node, the content node, and the community node are to be disposed using relationship data that is generated by the relationship data generator 220 (S910). The node position determiner 231 determines a position of the community node, a position of the user node, and a position of the content node with a method that is described with reference to FIGS. 4 to 6.

Next, the layer manager 232 disposes a corresponding node at a position that is determined by the node position determiner 231 within each layer (S912), and ties each layer by a link (line) according to a relationship thereof to generate an image layer (S914).

Thereafter, the visualizer 234 of the visualizing outputter 230 visualizes and outputs an association relationship between the user, the community, and the contents on a GUI based on the generated image layer (S916).

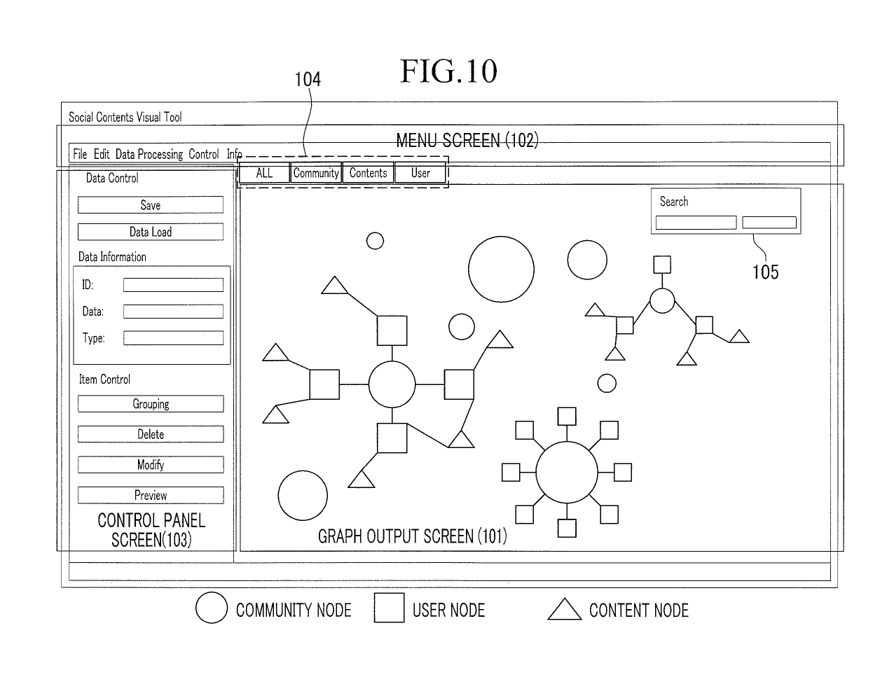

FIG. 10 is a diagram illustrating an example of a social network element that is displayed on a GUI by a visualizing apparatus of social network elements according to an exemplary embodiment of the present invention.

Referring to FIG. 10, nodes that are represented on the GUI are classified into a community node, a content node, and a user node, and an association relationship therebetween is represented by a line. Each community individually exists, and in a lower part thereof, a user node constituting the community is tied to the community. Further, the user node is tied to a content node corresponding thereto.

A screen that is displayed on the GUI includes a graph output screen 101, a menu screen 102, and a control panel screen 103.

The graph output screen 101 may be formed with a random tab panel 104 according to information classification. When a tab panel is selected, only corresponding information is displayed.

The menu screen 102 displays a main menu of a GUI, and the main menu is a menu of a function that is used in a program and a menu that is used for managing found data. The control panel screen 103 provides a processing function and information of data existing at the graph output screen 101. The control panel screen 103 provides a grouping function for grouping of elements and a function of deletion and correction. Here, when selecting a plurality of nodes and selecting grouping, the grouping function provides a function of forming a group in a user interface (UI) form or a function of separating a formed group to an individual node.

The graph output screen 101 provides a visualizing function of relationship data of a social network element and provides an information and function menu of an output node. That is, an association relationship between the user, the community, and the contents that are visualized by the visualizer 234 is output to the graph output screen 101.

The graph output screen 101 provides a search panel 105 for searching for incidentally output data to provide a function of enabling the user to easily search for data through a specific word.

According to an exemplary embodiment of the present invention, a user, a community, and contents are defined as elements of a social network, and when the user inputs a specific keyword, contents, a community group, and a user that are most related to the keyword can be three-dimensionally visualized based on a graph, and thus a circulation process of information can be analyzed, and a method and apparatus for visualizing social network elements can be used in a technical field that can search for and recommend information corresponding to the user's needs.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of visualizing social network elements in a visualizing apparatus of social network elements, the method comprising:
collecting social network relationship information, community information, and content information of a user;
generating relationship data between the user, contents, and community using the collected information; and
visualizing an association relationship between the user, the contents, and the community using the relationship data between the user, the contents, and the community.

2. The method of claim 1, wherein the visualizing of an association relationship comprises:
generating a user node, a content node, and a community node, respectively; and
tying the user node, the content node, and the community node with a link according to the association relationship between the user, the contents, and the community.

3. The method of claim 2, wherein the tying of the user node comprises:
generating a user layer, a content layer, and a community layer;
determining positions of the user node, the content node, and the community node to dispose at the user layer, the content layer, and the community layer, respectively; and
disposing the user node, the content node, and the community node at the respective determined positions.

4. The method of claim 3, wherein the determining of positions comprises:
determining a degree of the user using relationship data between the user, the contents, and the community;
setting an area at which the user node is to be disposed to correspond to the degree of the user; and
determining a position of the user node within the set area according to a distance to a community to which the user belongs.

5. The method of claim 4, wherein the degree is determined by a sum of a content number and a user number that are related to the user.

6. The method of claim 4, wherein the determining of positions further comprises:
determining a betweenness of the community using relationship data between the user, the contents, and the community; and
setting an area of the community according to the betweenness.

7. The method of claim 6, wherein the betweenness is determined by a sum of the number of users belonging to the community and the content number that is related to the user belonging to the community.

8. The method of claim 4, wherein the determining of positions further comprises disposing a content node that is associated with the corresponding user of the user node.

9. The method of claim 2, wherein the visualizing of an association relationship further comprises setting a size of the user node and the community node to the user's relationship level and a relationship level of the community.

10. A visualizing apparatus of social network elements, the visualizing apparatus comprising:
a data collector that collects social network relationship information, community information, and content information of a user;
a relationship data generator that generates relationship data between the user, contents, and a community using the collected information; and
a visualizing outputter that disposes a user node that is related to the community of a community node using the relationship data between the user, the contents, and the community, and that disposes a community node that is related to the user of the user node and that visualizes an associated node by tying with a link.

11. The visualizing apparatus of claim 10, wherein the visualizing outputter comprises:
a node position determiner that determines layers and positions at which the user node, the content node, and the community node are to be disposed; and
a layer manager that generates a user layer, a content layer, and a community layer and that disposes the user node, the content node, and the community node at the respective determined layers and positions and that ties an associated node with a link.

12. The visualizing apparatus of claim 11, wherein the node position determiner comprises:
an information manager that determines a degree of the user and a betweenness of the community;
an area setter that sets an area at which the community layer is to be positioned at the community layer based on the betweenness of the community, and that sets an area at which the user layer is to be positioned at the user layer based on the degree of the user; and
a position calculator that determines a position of the user node within an area at which the user node is to be positioned based on a distance to a community to which the user belongs.

13. The visualizing apparatus of claim 12, wherein the position calculator determines a position in which the sum of a distance to at least one community node to which the user node belongs is a minimum as a position of the user node within an area at which the user node is to be positioned.

14. The visualizing apparatus of claim 12, wherein the information manager determines the degree using a content number and a user number that are related to the user, and determines a betweenness using the user number belonging to the community and the content number that is related to the user belonging to the community.

15. The visualizing apparatus of claim 10, wherein the visualizing outputter extracts and visualizes, when receiving an input of node information to search for from the outside, only a node that is related to the corresponding node information.
